(19) United States
(12) Patent Application Publication
(10) Pub. No.: US 2016/0104880 A1
(43) Pub. Date: Apr. 14, 2016

(54) RAPID CHARGE LITHIUM-ION BATTERY

(71) Applicant: Dongguan Amperex Technology Limited, Dongguan (CN)

(72) Inventors: Chao GAO, Dongguan (CN); Shengwei WANG, Dongguan (CN); Jie CHEN, Dongguan (CN); Fuping LUO, Dongguan (CN); Qiang ZHENG, Dongguan (CN); Hongguang SHEN, Dongguan (CN)

(21) Appl. No.: 14/881,254

(22) Filed: Oct. 13, 2015

(30) Foreign Application Priority Data
Oct. 14, 2014 (CN) 201410543073.5

(51) Int. Cl. H01M 4/36; H01M 4/505; H01M 4/131; H01M 4/136; H01M 4/587; H01M 4/134; H01M 4/62; H01M 4/485; H01M 4/58; H01M 4/525; H01M 4/133

(52) U.S. Cl. CPC H01M 4/364; H01M 4/525; H01M 4/505; H01M 4/131; H01M 4/136; H01M 4/133; H01M 4/134; H01M 4/623; H01M 4/485; H01M 4/5825; H01M 4/587; H01M 2004/028

(57) ABSTRACT

A rapid charge lithium-ion battery comprises a positive plate, a negative plate, a separator disposed at intervals between the positive plate and the negative plate, and an electrolyte. The positive plate includes a positive current collector and a positive active material layer disposed on a surface of the positive current collector; the positive active material layer includes a positive active material, a positive conductive agent and a positive adhesive; the positive active material includes a component A and a component B; the component A is selected from at least one of lithium nickel cobalt aluminum oxide (NCA), lithium nickel cobalt manganese oxide (NCM), lithium manganese oxide (LMO) and lithium cobalt oxide (LiCoO₂); the component B is selected from at least one of lithium iron phosphate (LFP) and lithium titanium oxide (LTO); and the component B accounts for 5 to 90 percent by mass of the positive active material.

### FIELD OF THE INVENTION

The present invention belongs to the technical field of lithium-ion battery, in particular to a rapid charge lithium-ion battery with good high-magnification charge and discharge characteristic.

### BACKGROUND OF THE INVENTION

Lithium-ion battery, taken as a clean and environment-friendly functional element, has currently been more and more widely applied in more and more fields, e.g., the field of consumer electronics, the field of electric vehicles, the field of energy storage systems and the recently emerging balance car field.

Among them, the service power of commonly used consumer electronics, e.g., mobile phones and notebook computers, is higher and higher, and hence the requirement on the battery life of the lithium-ion battery is higher and higher. The battery life of the lithium-ion battery is mainly reflected in two aspects: energy density and charging speed. Currently, the enhancement of the energy density of the lithium-ion battery is increasingly difficult, and the acceleration of the charging speed of the lithium-ion battery and the reduction of the charging time of unit quantity of electricity are effective ways to prolong the battery life.

The acceleration of the charging speed of the lithium-ion battery can be performed from the aspects of the improvement of the charging method, the improvement of the battery chemistry system, the improvement of the battery structure and the like. So far, many patents or patent applications have disclosed technical proposals for modifying the charging method to accelerate the charging speed. But rapid charge battery chemistry systems, particularly rapid charge battery chemistry systems related to high energy density, are seldom disclosed.

### SUMMARY OF THE INVENTION

The objective of the present invention is to overcome the defects in the prior art and provide a rapid charge lithium-ion battery.

In order to achieve the above objective, the present invention adopts the technical proposal that: the present invention relates to a rapid charge lithium-ion battery, which comprises a positive plate, a negative plate, a separator disposed at intervals between the positive plate and the negative plate, and an electrolyte, wherein the positive plate includes a positive current collector and a positive active material layer disposed on a surface of the positive current collector; the positive active material layer comprises the following compositions in percentage by mass:

80 to 99 percent of positive active material;

0.1 to 10 percent of positive conductive agent; and

0.1 to 10 percent of positive adhesive;

the positive active material includes a component A and a component B; the component A is selected from at least one of lithium nickel cobalt aluminum oxide (NCA), lithium nickel cobalt manganese oxide (NCM), lithium manganese oxide (LMO) and lithium cobalt oxide (LiCoO₂); the component B is selected from at least one of lithium iron phosphate (LFP) and lithium titanium oxide (LTO); and

the component B accounts for 5 to 90 percent by mass of the positive active material.

Compared with the prior art, the rapid charge lithium-ion battery provided by the present invention has the following advantages:

Firstly, due to simple physical mixture of the component A and the component B, the rapid charge lithium-ion battery provided by the present invention not only can take into account both the characteristics of high gram specific capacity, high voltage plateau and the like of materials such as NCA, NCM, LMO and LiCoO₂ and the advantages of superior magnification performance and safety performance and the like of LFP and LTO but also can greatly simplify the process.

Secondly, the charging mode of the lithium-ion battery in the current industry is constant current charge and constant voltage charge. That is to say, the lithium-ion battery is charged to specific cut-off voltage (e.g., 4.2V) under the constant current and hence charged to specific current (e.g., 0.05C) under the constant voltage of the voltage, wherein the charging speed of the constant current charge period is much faster than that of the constant voltage charge period. Thus, if the charging speed is required to be accelerated, the constant current charge time (namely the ratio of the constant current charge capacity to the cell capacity) must be prolonged. Moreover, LFP and LTO have good magnification performance and low plateau, and the voltage plateau of LiCoO₂, LMO, NCM, NCA and the like is higher than that of LFP and LTO. After LFP/LTO (the component B) and LiCoO₂, LMO, NCM, NCA and the like (the component A) are mixed, the low-voltage constant current charge time can be prolonged, and hence the charging speed can be accelerated.

In addition, after LFP/LTO (the component B) and LiCoO₂, LMO, NCM, NCA and the like (the component A) are mixed, the overall voltage plateau of the positive active material is higher than respective plateau of LFP and LTO. Due to the stable structure of LFP and LTO, the positive active material can operate under high voltage. Thus, the delithiation ratio can be increased, and hence respective gram specific capacity can be improved, and consequently the energy density can be improved. Experiments show that: when the charge cut-off voltage of a graphite negative electrode is 3.65V, the gram specific capacity of LFP is 141.2 mAh/g; and when the cut-off voltage is 4.0V, the gram specific capacity of LFP is 142.6 mAh/g. Thus, the gram specific capacity of LFP is improved by about 1%.

The mass percentage of the component B in the positive active material cannot be too high, or else, the capacity and the discharge plateau of the battery can be reduced; but the mass percentage cannot be too low, or else, the charging speed of the battery cannot be accelerated.

As an improvement of the rapid charge lithium-ion battery provided by the present invention, the component A is doped with 0.1 to 1 percent by mass of metallic element which is selected from at least one of Mg, Zr, Ti, Zn, V and Cr. Due to doping, the structure stability of the component A can be improved, and hence the safety of the battery can be improved.

As an improvement of the rapid charge lithium-ion battery provided by the present invention, the surface of the component A is coated with an oxide layer which is selected from at least one of Al₂O₃, ZrO₂, Y₂O₃, MgO and TiO; and the ratio of the mass of the oxide layer to the mass of the component A is (0.1-2):100. Due to coating, the structure stability of the component A can be improved, and hence the safety of the battery can be improved.

As an improvement of the rapid charge lithium-ion battery provided by the present invention, the external surface of LFP is coated with a carbon layer; and the ratio of the mass of the carbon layer to the mass of LFP is (0.1-2):100. As the surface of LFP is coated with the carbon layer, the electric conductivity of LFP can be improved.

As an improvement of the rapid charge lithium-ion battery provided by the present invention, the negative plate includes a negative current collector and a negative active material layer disposed on a surface of the negative current collector; and the negative active material layer comprises the following compositions in percentage by mass:

80 to 97 percent of negative active material;

1 to 18 percent of negative conductive agent;

1 to 18 percent of negative adhesive; and

1 to 18 percent of negative stabilizer.

As an improvement of the rapid charge lithium-ion battery provided by the present invention, the negative active material is selected from at least one of artificial graphite, natural graphite, mesocarbon microbeads, soft carbon, hard carbon, silicon, silicon dioxide and tin alloy.

As an improvement of the rapid charge lithium-ion battery provided by the present invention, both the negative adhesive and the positive adhesive are selected from at least one of polyvinylidene fluoride (PVDF), styrene-butadiene rubber (SBR), sodium alginate (SA), polyvinyl alcohol (PVA) and polytetrafluoroethylene (PTFE).

As an improvement of the rapid charge lithium-ion battery provided by the present invention, the negative stabilizer is selected from at least one of sodium carboxymethyl cellulose (CMC), sodium hydroxypropyl methyl cellulose (HPMC) and sodium hydroxymethyl cellulose (HMC).

As an improvement of the rapid charge lithium-ion battery provided by the present invention, both the negative conductive agent and the positive conductive agent are carbon black, or are selected from at least one of carbon fiber, carbon nano-tube, carbon nano-rod and graphene, or are a mixture of carbon black and at least one selected from carbon fiber, carbon nano-tube, carbon nano-rod, phosphorus graphite and graphene.

In the positive conductive agents, the carbon fiber, the carbon nano-tube and the carbon nano-rod are all one-dimensional materials; the phosphorus graphite and the graphene are two-dimensional materials; and the carbon black is a zero-dimensional material. The one-dimensional/two-dimensional conducting material is mixed with the zero-dimensional material carbon black to form a conductive agent, so that active material particles can be better connected in series, and hence the conductive effect is better and the content of the conductive agent can be reduced. Meanwhile, the conductive agent also has the function of similar adhesive, so that the content of the adhesive can be appropriately reduced and the content of the active material can be increased, and hence the energy density can be improved.

### BRIEF DESCRIPTION OF THE DRAWINGS

Detailed description will be given below to the present invention and the advantages of the present invention with reference to the accompanying drawings and the preferred embodiments.

FIG. 1 illustrates 5C charging speed curves of an embodiment 1 and a comparative example 1 of the rapid charge lithium-ion battery provided by the present invention; and

FIG. 2 illustrates 10C/10C cyclic curves of the embodiment 1 and the comparative example 1 of the rapid charge lithium-ion battery provided by the present invention.

### DETAILED DESCRIPTION OF THE PREFERRED EMBODIMENTS

### Embodiment 1

The embodiment provides a lithium-ion battery, which comprises a positive plate, a negative plate, a separator disposed at intervals between the positive plate and the negative plate, and an electrolyte;

the positive plate includes a positive current collector and a positive active material layer disposed on a surface of the positive current collector; the positive active material layer comprises the following compositions in percentage by mass:

80% of positive active material NCM;

15% of positive active material LFP;

2.5% of positive conductive agent carbon black; and

2.5% of positive adhesive PVDF; and

the positive current collector is an aluminum foil with the thickness of 16 pms.

The negative plate includes a negative current collector and a negative active material layer disposed on a surface of the negative current collector; the negative active material layer comprises the following compositions in percentage by mass:

94% of negative active material natural graphite;

2% of negative conductive agent carbon black;

2% of negative adhesive SBR; and

2% negative stabilizer CMC; and

the negative current collector is a copper foil with the thickness of 12 pms.

The electrolyte includes an organic solvent, an additive and a lithium salt. The organic solvent is a mixture of dimethyl carbonate (DMC), diethyl carbonate (DEC) and ethylene carbonate (EC) the volume of which is 2:2:3. The additive includes propane sultone (PS) which accounts for 1% of the total mass of the electrolyte and fluoroethylene carbonate (FEC) which accounts for 2% of the total mass of the electrolyte. The lithium salt is LiFP₆ with the concentration of 1 mol/L.

The separator is polyethylene (PE) with the thickness of 16 pms.

The method for preparing the battery, provided by the embodiment, comprises:

the preparation of the positive plate: adding 80% of NCM, 15% of LFP, 2.5% of carbon black and 2.5% of PVDF into N-methylpyrrolidone (NMP) for mixing to form slurry, uniformly coating the slurry on an aluminum foil so that the surface density of the aluminum foil is 18 mg/cm², and drying, rolling and cutting the aluminum foil to obtain the positive plate.

the preparation of the negative plate: adding 94% of natural graphite, 2% of carbon black, 2% of SBR and 2% of CMC into distilled water for mixing to form slurry, uniformly coating the slurry on a copper foil so that the surface density of the copper foil is 10 mg/cm², and drying, rolling and cutting the copper foil to obtain the negative plate.

the preparation of a cell: winding the positive plate, the negative plate and the separator to form a cell, wherein the positive plate and the negative plate are separated from each other by the separator; positive tabs and negative tabs are respectively welded on the positive plate and the negative plate by ultrasonic wave; and finally the cell is placed in an aluminum film for backing to remove the moisture in the cell;

filling: filling a specific amount of electrolyte into the baked cell, and sealing the cell and keeping stand, so that the positive plate, the negative plate and the separator are all fully soaked into the electrolyte;

and finally the formation of the cell and the aging of the cell for a period of time to obtain the high-magnification lithium-ion battery.

### Comparative Example 1

The differences from the embodiment 1 are as follows: the mass content of NCM is 90%; the mass content of carbon black is 5%; and the mass content of PVDF is 5%. Others are the same with those of the embodiment 1. No further description will be given here.

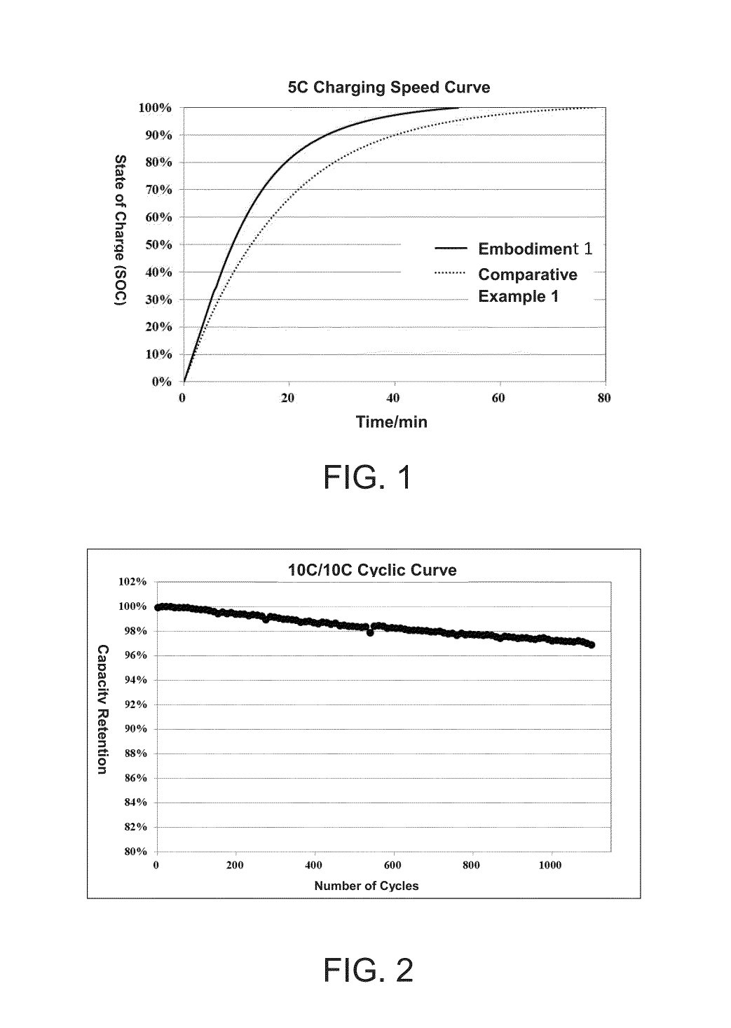

The capacity and charge and discharge tests are performed on the batteries provided by the embodiment 1 and the comparative example 1. The charging mode is as follows: the battery is charged to 4.2V under 5C or 10C constant current at first and hence charged to 0.05C under 4.2V constant voltage. The results are shown in Table 1. In addition, FIG. 1 illustrates 5C (magnification) charging speed curves of the embodiment 1 and the comparative example 1. As seen from Table 1 and FIG. 1, the battery provided by the present invention has higher charging speed rise compared with the comparative example 1.

The cycle life test is performed on the batteries provided by the embodiment 1 and the comparative example 1. The cycle is set to be 10C charge/discharge accelerated cycle. The results are shown in Table 1 and FIG. 2. As seen from Table 1 and FIG. 2, after 1000 cycles, the capacity retention of the battery provided by the present invention is 97.1%; but the capacity retention of the battery provided by the comparative example 1 is 95.5%. It indicates that the battery provided by the present invention has better high-magnification charge and discharge characteristic.

### Embodiment 2

The differences from the embodiment 1 are as follows: the positive active material is a mixture of NCA and LFP the mass ratio of which is 70:25; the surface of LFP is coated with a carbon layer; the ratio of the mass of the carbon layer to the mass of LFP is 1:100; the mass content of the positive active material is 95%; the positive conductive agent is a mixture of carbon nano-tube and carbon black the mass ratio of which is 1:1; and the positive adhesive is SA. Others are the same with those of the embodiment 1. No further description will be given here.

### Comparative Example 2

The differences from the embodiment 2 are as follows: the positive active material is NCA the mass content of which is 90%; the positive conductive agent is carbon black; the mass content of the positive conductive agent is 5%; and the mass content of the positive adhesive is 5%. Others are the same with those of the embodiment 2. No further description will be given here.

The capacity and charge and discharge tests are performed on the batteries provided by the embodiment 2 and the comparative example 2. The charging mode is as follows: the battery is charged to 4.2V under 5C or 10C constant current at first and hence charged to 0.05C under 4.2V constant voltage. The results are shown in Table 1. As seen from Table 1, the battery provided by the present invention has higher charging speed rise compared with the comparative example 2.

The cycle life test is performed on the batteries provided by the embodiment 2 and the comparative example 2. The cycle is set to be 100 charge/discharge accelerated cycle. The results are shown in Table 1. As seen from Table 1, after 1000 cycles, the capacity retention of the battery provided by the present invention is 96.8%; but the capacity retention of the battery provided by the comparative example 2 is 92.3%. It indicates that the battery provided by the present invention has better high-magnification charge and discharge characteristic.

### Embodiment 3

The differences from the embodiment 1 are as follows: the positive active material is a mixture of LiCoO₂ and LFP the mass ratio of which is 80:10; the mass content of the positive active material is 90%; LiCoO₂ is doped with 1% by mass of Mg; the surface of LFP is coated with a carbon layer; the ratio of the mass of the carbon layer to the mass of LFP is 0.5:100; the positive conductive agent is a mixture of carbon nano-tube and graphene; the mass content of the carbon nano-tube is 2%; the mass content of the graphene is 3%; the positive adhesive is PVA; and the mass content of the positive adhesive is 5%. Others are the same with those of the embodiment 1. No further description will be given here.

### Comparative Example 3

The differences from the embodiment 3 are as follows: the positive active material is undoped LiCoO₂; and the positive conductive agent is carbon black. Others are the same with those of the embodiment 3. No further description will be given here.

The capacity and charge and discharge tests are performed on the batteries provided by the embodiment 3 and the comparative example 3. The charging mode is as follows: the battery is charged to 4.2V under 5C or 10C constant current at first and hence charged to 0.05C under 4.2V constant voltage. The results are shown in Table 1. As seen from Table 1, the battery provided by the present invention has higher charging speed rise compared with the comparative example 3.

The cycle life test is performed on the batteries provided by the embodiment 3 and the comparative example 3. The cycle is set to be 100 charge/discharge accelerated cycle. The results are shown in Table 1. As seen from Table 1, after 1000 cycles, the capacity retention of the battery provided by the present invention is 97.0%; but the capacity retention of the battery provided by the comparative example 3 is 96.2%. It indicates that the battery provided by the present invention has better high-magnification charge and discharge characteristic.

### Embodiment 4

The differences from the embodiment 1 are as follows: the positive active material is a mixture of LiCoO₂, NCM and LFP the mass ratio of which is 40:20:32; the surface of LiCoO₂ is coated with a Al₂O₃ layer; the ratio of the mass of the Al₂O₃ layer to the mass of LiCoO₂ is 1:100; the positive conductive agent is a mixture of carbon black and carbon fiber; the mass content of the carbon black is 2%; the mass content of the carbon fiber is 3.5%; the positive adhesive is PVA; the negative active material is a mixture of natural graphite and artificial graphite the mass ratio of which is 1:1; the negative adhesive is SA; the negative conductive agent is a mixture of graphene and graphitized carbon black the mass ratio of which is 1:4; and the negative stabilizer is HPMC. Others are the same with those of the embodiment 1. No further description will be given here.

### Comparative Example 4

The differences from the embodiment 4 are as follows: the positive active material is a mixture of LiCoO₂ and NCM the mass ratio of which is 2:1; and the positive conductive agent is carbon black the mass content of which is 5.5%. Others are the same with those of the embodiment 4. No further description will be given here.

The capacity and charge and discharge tests are performed on the batteries provided by the embodiment 4 and the comparative example 4. The charging mode is as follows: the battery is charged to 4.2V under 5C or 10C constant current at first and hence charged to 0.05C under 4.2V constant voltage. The results are shown in Table 1. As seen from Table 1, the battery provided by the present invention has higher charging speed rise compared with the comparative example 4.

The cycle life test is performed on the batteries provided by the embodiment 4 and the comparative example 4. The cycle is set to be 10C charge/discharge accelerated cycle. The results are shown in Table 1. As seen from Table 1, after 1000 cycles, the capacity retention of the battery provided by the present invention is 95.6%; but the capacity retention of the battery provided by the comparative example 4 is 93.4%. It indicates that the battery provided by the present invention has better high-magnification charge and discharge characteristic.

### Embodiment 5

The differences from the embodiment 1 are as follows: the positive active material is a mixture of LiCoO₂, LMO and LFP the mass ratio of which is 40:20:25; the surface of LiCoO₂ is coated with a ZrO₂ layer; the ratio of the mass of the ZrO₂ layer to the mass of LiCoO₂ is 0.5:100; LMO is doped with 0.5% by mass of Ti; the positive conductive agent is a mixture of carbon black and phosphorus graphite; the mass content of the carbon black is 5%; the mass content of the phosphorus graphite is 5%; the positive adhesive is SBR; the mass content of the positive adhesive is 5%; the negative active material is a mixture of mesocarbon microbeads and soft carbon the mass ratio of which is 3:1; the negative adhesive is PVDF; and the negative conductive agent is a mixture of carbon fiber and graphitized carbon black the mass ratio of which is 1:4. Others are the same with those of the embodiment 1. No further description will be given here.

### Comparative Example 5

The differences from the embodiment 5 are as follows: the positive active material is a mixture of LiCoO₂ and LMO the mass ratio of which is 2:1; and the positive conductive agent is carbon black the mass content of which is 10%. Others are the same with those of the embodiment 5. No further description will be given here.

The capacity and charge and discharge tests are performed on the batteries provided by the embodiment 5 and the comparative example 5. The charging mode is as follows: the battery is charged to 4.2V under 5C or 10C constant current at first and hence charged to 0.05C under 4.2V constant voltage. The results are shown in Table 1. As seen from Table 1, the battery provided by the present invention has higher charging speed rise compared with the comparative example 5.

The cycle life test is performed on the batteries provided by the embodiment 5 and the comparative example 5. The cycle is set to be 100 charge/discharge accelerated cycle. The results are shown in Table 1. As seen from Table 1, after 1000 cycles, the capacity retention of the battery provided by the present invention is 97.8%; but the capacity retention of the battery provided by the comparative example 5 is 96.2%. It indicates that the battery provided by the present invention has better high-magnification charge and discharge characteristic.

### Embodiment 6

The differences from the embodiment 1 are as follows: the positive active material is a mixture of LiCoO₂ and LTO the mass ratio of which is 80:15. Others are the same with those of the embodiment 1. No further description will be given here.

### Comparative Example 6

The differences from the embodiment 6 are as follows: the positive active material is LiCoO₂; the mass content of the positive active material is 90%; the mass content of the positive conductive agent is 5%; and the mass content of the positive adhesive is 5%. Others are the same with those of the embodiment 6. No further description will be given here.

The capacity and charge and discharge tests are performed on the batteries provided by the embodiment 6 and the comparative example 6. The charging mode is as follows: the battery is charged to 4.2V under 5C or 10C constant current at first and hence charged to 0.05C under 4.2V constant voltage. The results are shown in Table 1. As seen from Table 1, the battery provided by the present invention has higher charging speed rise compared with the comparative example 6.

The cycle life test is performed on the batteries provided by the embodiment 6 and the comparative example 6. The cycle is set to be 100 charge/discharge accelerated cycle. The results are shown in Table 1. As seen from Table 1, after 1000 cycles, the capacity retention of the battery provided by the present invention is 97.3%; but the capacity retention of the battery provided by the comparative example 6 is 96.2%. It indicates that the battery provided by the present invention has better high-magnification charge and discharge characteristic.

### Embodiment 7

The differences from the embodiment 1 are as follows: the positive active material is a mixture of LiCoO₂, LFP and LTO the mass ratio of which is 65:15:15; LiCoO2 is doped with 0.7% by mass of V; the surface of LiCoO₂ is coated with a MgO layer; and the ratio of the mass of the MgO layer to the mass of LiCoO₂ is 1.5:100. Others are the same with those of the embodiment 1. No further description will be given here.

### Comparative Example 7

The differences from the embodiment 7 are as follows: the positive active material is LiCoO₂; the mass content of the positive active material is 90%; the mass content of the positive conductive agent is 5%; and the mass content of the positive adhesive is 5%. Others are the same with those of the embodiment 7. No further description will be given here.

The capacity and charge and discharge tests are performed on the batteries provided by the embodiment 7 and the comparative example 7. The charging mode is as follows: the battery is charged to 4.2V under 5C or 10C constant current at first and hence charged to 0.05C under 4.2V constant voltage. The results are shown in Table 1. As seen from Table 1, the battery provided by the present invention has higher charging speed rise compared with the comparative example 7.

The cycle life test is performed on the batteries provided by the embodiment 7 and the comparative example 7. The cycle is set to be 100 charge/discharge accelerated cycle. The results are shown in Table 1. As seen from Table 1, after 1000 cycles, the capacity retention of the battery provided by the present invention is 97.3%; but the capacity retention of the battery provided by the comparative example 7 is 96.2%. It indicates that the battery provided by the present invention has better high-magnification charge and discharge characteristic.

TABLE 1
Test Results of Batteries Provided by the Embodiments 1 to 7 and
the Comparative Examples 1 to 7

| | | Capacity | |
|---|---|---|---|
| | 5 C Full | Retention | Capacity Retention under |
| | Charge | under 5 C | 10 C Charge/Discharge/ |
| Group | Time/min | Discharge | 1000 Cycles |
| Embodiment 1 | 52 | 93% | 97.1% |
| Comparative | 78 | 92% | 95.5% |
| Example 1 | | | |
| Embodiment 2 | 54 | 94% | 96.8% |
| Comparative | 79 | 91% | 92.3% |
| Example 2 | | | |
| Embodiment 3 | 50 | 97% | 97.0% |
| Comparative | 76 | 94% | 96.2% |
| Example 3 | | | |
| Embodiment 4 | 55 | 93% | 95.6% |
| Comparative | 73 | 91% | 93.4% |
| Example 4 | | | |
| Embodiment 5 | 58 | 96% | 97.8% |
| Comparative | 76 | 94% | 96.2% |
| Example 5 | | | |
| Embodiment 6 | 57 | 95% | 97.3% |
| Comparative | 76 | 94% | 96.2% |
| Example 6 | | | |
| Embodiment 7 | 52 | 96% | 97.4% |
| Comparative | 76 | 94% | 96.2% |
| Example 7 | | | |

As seen from Table 1, the present invention can improve the charging speed of the battery and improve the high-magnification charge/discharge characteristic of the battery to some extent.

According to the disclosure and instruction of the description, changes and modifications may be made to the embodiments by those skilled in the art. Thus, the present invention is not limited to the preferred embodiments as disclosed and described above. Some modifications and changes made to the present invention shall also fall within the scope of protection of the appended claims of the present invention. In addition, although some specific terms are used in the description, the terms are only used for convenient description and not intended to limit the present invention.

What is claimed is:

1. A rapid charge lithium-ion battery, comprising a positive plate, a negative plate, a separator disposed at intervals between the positive plate and the negative plate, and an electrolyte, wherein
the positive plate includes a positive current collector and a positive active material layer disposed on a surface of the positive current collector; the positive active material layer comprises the following compositions in percentage by mass:
80 to 99 percent of positive active material;
to 10 percent of positive conductive agent; and
0.1 to 10 percent of positive adhesive;
the positive active material includes a component A and a component B; the component A is selected from at least one of lithium nickel cobalt aluminum oxide (NCA), lithium nickel cobalt manganese oxide (NCM), lithium manganese oxide (LMO) and lithium cobalt oxide (LiCoO2); the component B is selected from at least one of lithium iron phosphate (LFP) and lithium titanium oxide (LTO); and
the component B accounts for 5 to 90 percent by mass of the positive active material.

2. The rapid charge lithium-ion battery according to claim 1, wherein the component A is doped with 0.1 to 1 percent by mass of metallic element which is selected from at least one of Mg, Zr, Ti, Zn, V and Cr.

3. The rapid charge lithium-ion battery according to claim 1, wherein the surface of the component A is coated with an oxide layer which is selected from at least one of Al2O3, ZrO2, Y2O3, MgO and TiO; and the ratio of the mass of the oxide layer to the mass of the component A is (0.1-2):100.

4. The rapid charge lithium-ion battery according to claim 1, wherein the external surface of LFP is coated with a carbon layer; and the ratio of the mass of the carbon layer to the mass of LFP is (0.1-2):100.

5. The rapid charge lithium-ion battery according to claim 1, wherein the negative plate includes a negative current collector and a negative active material layer disposed on a surface of the negative current collector; and the negative active material layer comprises the following compositions in percentage by mass:
80 to 97 percent of negative active material;
1 to 18 percent of negative conductive agent;
1 to 18 percent of negative adhesive; and
1 to 18 percent of negative stabilizer.

6. The rapid charge lithium-ion battery according to claim 1, wherein the negative active material is selected from at least one of artificial graphite, natural graphite, mesocarbon microbeads, soft carbon, hard carbon, silicon, silicon dioxide and tin alloy.

7. The rapid charge lithium-ion battery according to claim 5, wherein both the negative adhesive and the positive adhesive are selected from at least one of polyvinylidene fluoride (PVDF), styrene-butadiene rubber (SBR), sodium alginate (SA), polyvinyl alcohol (PVA) and polytetrafluoroethylene (PTFE).

8. The rapid charge lithium-ion battery according to claim 5, wherein the negative stabilizer is selected from at least one of sodium carboxymethyl cellulose (CMC), sodium hydroxypropyl methyl cellulose (HPMC) and sodium hydroxymethyl cellulose (HMC).

9. The rapid charge lithium-ion battery according to claim 5, wherein both the negative conductive agent and the positive conductive agent are carbon black, or are selected from at least one of carbon fiber, carbon nano-tube, carbon nano-rod and graphene, or are a mixture of carbon black and at least one selected from carbon fiber, carbon nano-tube, carbon nano-rod, phosphorus graphite and graphene.
